(19) United States
(12) Patent Application Publication
(10) Pub. No.: US 2018/0114315 A1
(43) Pub. Date: Apr. 26, 2018

(54) Analysis Method of Blood Platelets Aggregate

(71) Applicant: Université Libre de Bruxelles, Bruxelles (BE)

(72) Inventors: Frank Dubois, Bruxelles (BE); Catherine Yourassowsky, Bruxelles (BE); Pierrick Uzureau, Velaine Sur Sambre (BE); Daniel Ribeiro De Souza, Mons (BE); Karim Zouaoui Boudjeltia, Lobbes (BE)

(21) Appl. No.: 15/567,790

(22) PCT Filed: Apr. 25, 2016
(86) PCT No.: PCT/EP2016/059166

§ 371 Date: Oct. 19, 2017

(30) Foreign Application Priority Data
Apr. 24, 2015 (EP) 15164996.9

(51) Int. Cl. G06T 7/00; G06T 7/62

(52) U.S. Cl. CPC G06T 7/0012; G06T 7/62; G06T 2207/30104; G06T 2207/10056; G06T 2207/30024; G06T 2207/10028

(57) ABSTRACT

Quantitative analysis of blood platelets or aggregates in 3D by Digital Holographic Microscopy. The present invention is related to a method for the quantitative analysis of blood platelets or blood platelet aggregates comprising the steps of: a) providing a sample comprising platelets aggregates; b) obtain a 3D representation of the platelets aggregates by the use of DHM or DDHM; c) extract quantitative information about the platelets aggregates from said 3D representation.

### FIELD OF THE INVENTION

The present invention is related to the use of digital holographic microscopy (DHM) or differential digital holographic microscopy (DDHM) for the quantitative analysis of platelets or platelets aggregates.

### BACKGROUND

The platelet spreading and retraction play a pivotal role in the platelet plugging and the thrombus formation. In routine laboratory, platelet function tests include exhaustive information about the role of the different receptors present at the platelet surface without information on the 3D structure of platelet aggregates.

Blood leakage at the site of endothelium failure is counteracted by a two-step process, the haemostasis: the primary haemostasis step involves thrombocytes, the platelets coming together to form a plug, while in the secondary haemostasis step, the coagulation factors of the bloodstream form a fibrin meshwork. Platelets are 2-3 μm wide of cytoplasm with biconvex disc shape exclusively found in the blood of mammals.

They form a plug in a stepwise mechanism. First, circulating platelets are recruited at the site of injury by the exposure of deep tissue structures. The adhesion of these platelets to the surface triggers the recruitment and aggregation of novel platelets. Upon platelet adhesion, surface receptors are activated.

Thanks to these receptors, platelets are bridged together through the interaction with factors such as fibrinogen or Von Willebrand factor (vWF) that present multiple binding sites. Activation also triggers morphological changes of the platelets. Upon adhesion on the wound, the round shaped platelets of the bloodstream flatten on the surface and develop filopodia which intertwine and tighten the platelet aggregate.

Thus for more than 4 decades, factors inducing platelet aggregation seemed straightforward, requiring a stimulus, a soluble protein (fibrinogen), and a membrane-bound platelet receptor (integrin αIIbβ3 or GPIIb-IIIa), leading to a simple unified model of platelet aggregation as described by K S. Sakariassen, E. Fressinaud, J P. Girma, D. Meyer and Baumgartner in: “Role of platelet membrane glycoproteins and von Willebrand factor in adhesion of platelets to subendothelium and collagen”. Ann N Y Acad Sci. 516:52-65 (1987). However, recent technical advances allowing real time analysis of platelet aggregation in-vitro and in animal models demonstrated much more complex dynamical processes than previously expected (Jakson et Al. “Dynamics of platelet thrombus formation.” J Thromb Haemost. 7 Suppl 1:17-20 (2009)).

In particular, the mechanisms by which hemodynamic conditions lead to platelets adhesion and aggregation are still incompletely understood. Actual results suggest that platelet tethering requires different receptor/ligand pairs at low (up to 1000 s⁻¹: fibrinogen/integrin αIIbβ3) and high (up to 10000 s⁻¹: vWF/GPIb glycoprotein bonds) shear rates of the bloodstream (SP. Jackson. The growing complexity of platelet aggregation. Blood 109:5087-5095 (2007)).

In clinical practice, platelet function tests include exhaustive information about the role of the different receptors present at the surface of platelets. These tests are mainly based on turbidimetric optical detection, multiple electrode aggregometry and flow cytometry. With these tests, it is impossible to analyze an important process after platelets adhesion, the spreading and the retraction. And yet, the spreading and the retraction play a pivotal role in the platelet adhesion and the thrombus formation.

### AIMS OF THE INVENTION

The present invention aims to provide a method for quantitative 3D morphology of platelet aggregation.

### SUMMARY OF THE INVENTION

The present invention is related to a method for the quantitative analysis of cells or cells aggregates comprising the steps of:
a) providing a sample comprising cells or cells aggregates;
b) obtain a 3D representation of cells or cells aggregates by the use of DHM or DDHM;
c) extract quantitative information about the cells or cells aggregates from said 3D representation.

Preferred embodiments of the present invention disclose at least one or a suitable combination of the following features:
said quantitative information is related to the group consisting of volume, spreading, surface, surface to volume ratio, squared aggregate perimeter to aggregate area ratio (i.e. P²/_{S}, where P is the perimeter);
said cells or cells aggregates are platelets or platelets aggregates adhering on a surface, the platelets being preferably provided in suspension and submitted to a predefined shear rate in the vicinity of the surface prior to observation by DHM or DDHM;
the quantitative analysis is performed dynamically, step b) and c) being performed iteratively on a sample submitted to a controlled shear rate;
the method comprises the step of acquiring both holographic and fluorescence images of the cells;
the method comprises the step of subtracting an estimation of the background prior to quantitative analysis.

### FIGURES

FIG. 1 (a) Platelet aggregates picture obtained with the Impact-R camera (original magnification ×400). The whole blood was exposed to a shear rate of 100 s−1. (b) Scan Electron Microscopy of platelet aggregates in the well.

FIG. 2. Digital holographic microscope scheme GG: Rotating Ground Glass; L1 and L2: Lenses; BS1 and BS2: Beam Splitters; ML1-3: Microscope Lenses, M1-5: Mirrors.

FIG. 3. (a) Phase image showing platelet aggregates obtained with DHM (scale bar=20 μm). The background phase value (Region where there is no platelet) is arbitrarily set to be equal to the grey level 30 in average. (b) The phase image of (a) is multiplied by a binary mask in order to keep the only background region. For visibility purpose, the phase values are multiplied by a factor 2.

FIG. 4. (a) The well positioned on the DHM for analysis, (b) Hologram with a zoom on platelets aggregate. (c) Hologram intensity with an insert showing the fringe pattern deformation due to a platelet aggregate d) The phase image with an insert representing the 3D extraction of the platelets aggregate based on the optical high (grey scale). (scale bar=20 μm)

FIG. 5. (a), (b), (c) Comparison between respectively heights, surfaces and volumes of platelets aggregates obtained with the whole blood exposed to a shear rate of 100 s−1, after 20 sec and 300 sec. (d) and (e) Correlations between the aggregates volumes and the surface-height product obtained at 20 sec and 300 respectively.

### DETAILED DESCRIPTION OF THE INVENTION

The present invention discloses a method able to characterize the 3D platelets or aggregates shapes by using the quantitative phase contrast imaging provided by DHM or DDHM. This original method will be of a great interest in the study of platelets physiology in clinical practice and in the development of new drugs.

DHM suitable for the present invention are for example disclosed in patent documents EP1399730, EP1631788, and EP2357539.

### EXAMPLE

### Example 1: Aggregate Volume Determination

### Materials and Methods

### Aggregates Formation: The Impact-R Test.

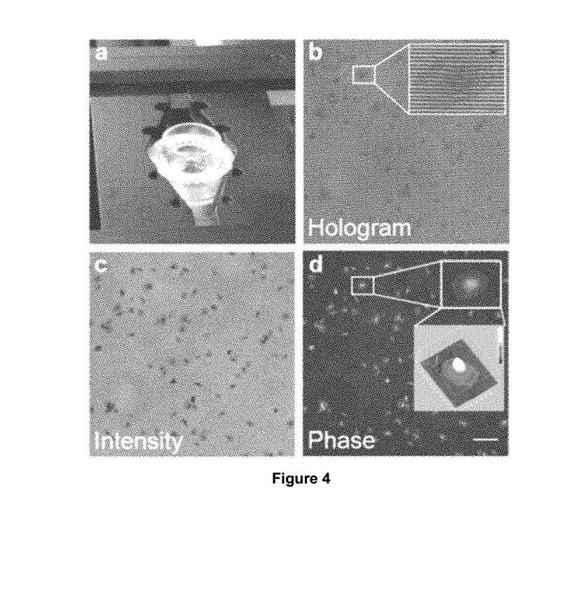

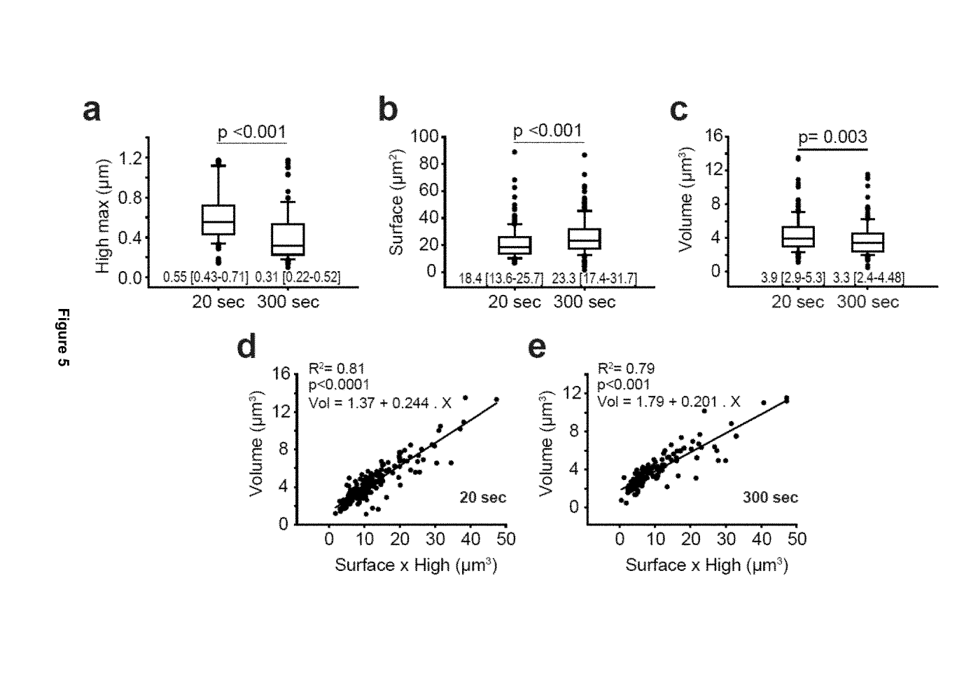

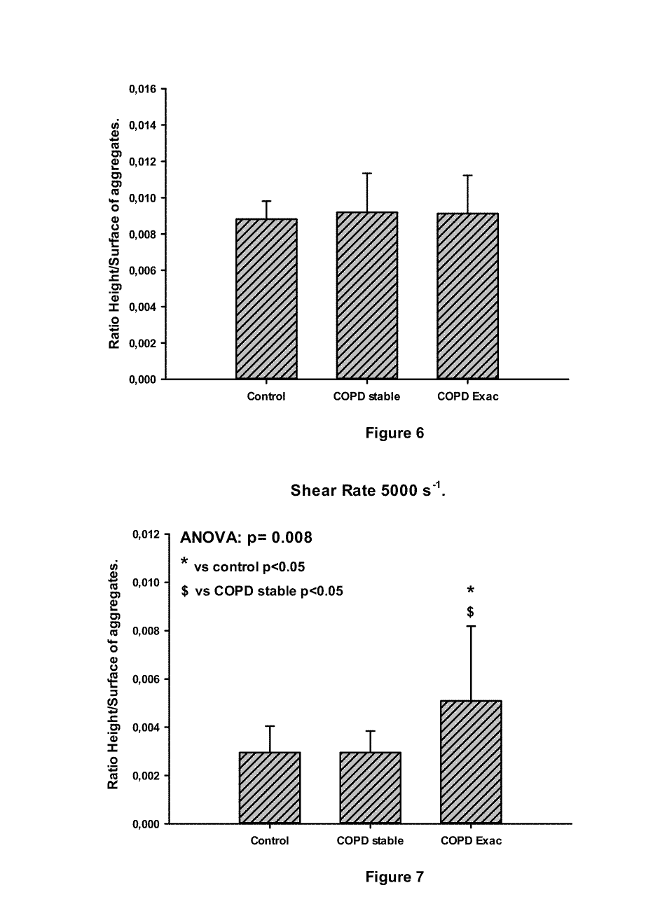

Blood sampling was approved by the CHU Charleroi hospital ethics committee (Comite'd'Ethique I.S.P.PC: OM008). The studies conform to the principles outlined in the Declaration of Helsinki. Venous blood was drawn from healthy donors (from the Centre Hospitalier Universitaire de Charleroi, Belgium) into tubes with 3.2% sodium citrate solution, pH 7.4. A cone and plate device (Impact-R, Diamed©) was used (FIG. 4 a).

The platelet aggregates formation was induced by exposing 130 μL of whole blood in a well to laminar flow using the disposable Teflon conical rotors. After washing, images on a circumferential plane from the wells were captured by the image analyzer on impact-R, which quantifies the platelet aggregates formed, in 2D, on the surface. The results were expressed as number of aggregates detected and the average area of the aggregates, according to the shear forces. Two sets of test were performed, with the blood samples exposed to a shear rate of 100 s⁻¹ during 20 sec and 300 sec.

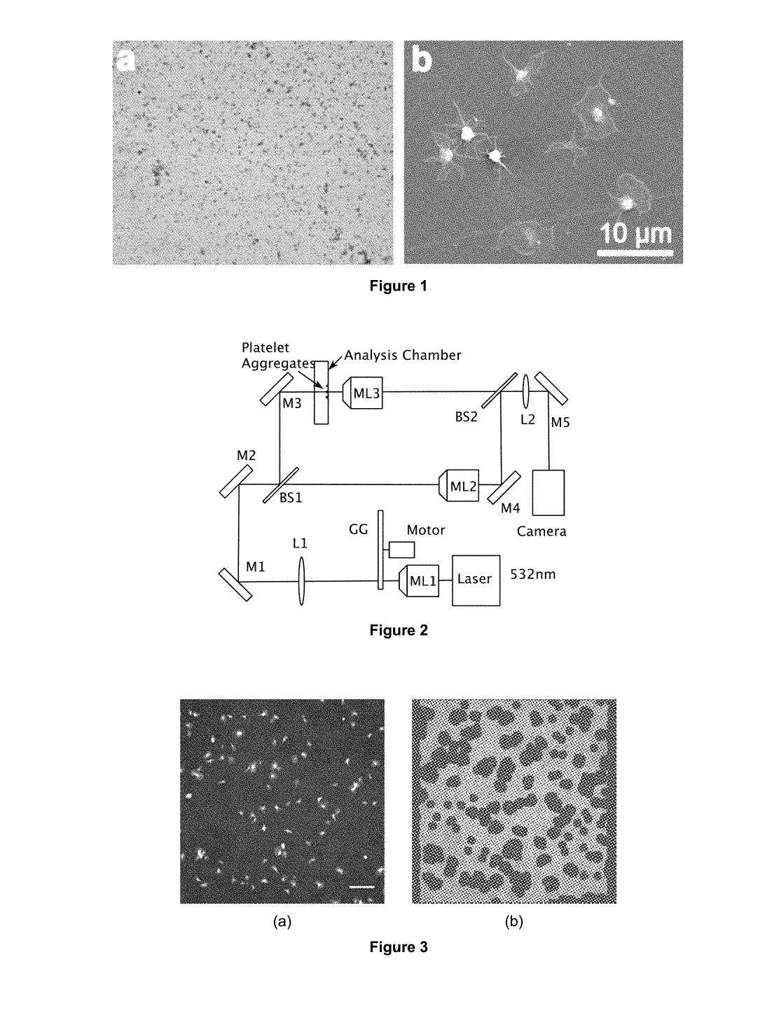

The FIG. 1 shows the platelet aggregates observed in the well with the Impact-R microscope and by scan electron microscopy (SEM). By SEM the platelet spreading is clearly observable on small aggregates.

### DHM Setup

This section describes the off-axis DHM with a source of partially spatial coherence light to record the holographic information. The configuration is shown in FIG. 2.

A coherent source (a mono-mode laser diode, λ=532 nm) is made partially spatial coherent by focusing the beam, by the lens ML1, close to the rotating plane of the ground glass (GG). The lens L1 collimates the beam that is divided by a beam splitter BS1. The object beam reflected by BS1 illuminates the sample in the analysis chamber in transmission. The plane, on which the platelet aggregates are sticking, is imaged by the couple of lenses ML3-L2 on the CCD camera sensor. The reference beam transmitted by the beam splitter BS1 has a similar optical path, excepted that there is no analysis chamber with a sample. The two beams are interfering on the CCD sensor.

The reference beam is slanted on the sensor with respect to the object beam in such a way that a grating-like thin interference pattern is recorded. This off-axis configuration enables to implement the Fourier method to compute the complex amplitude of the object beam for every recorded frame. Thanks to the partially coherent illumination, raw holograms directly displayed on the PC screen are with low noise and fully meaningful for the operator as with an usual microscope (FIG. 4 b). With full coherent illumination, the direct image displayed on the screen is usually too noisy to be interpreted by a direct viewing.

The microscope lenses ML2 and ML3 are Leica 40×, NA 0.6. The camera is a JAI, with a CCD providing holograms of 1024×1024 pixels, with a pixel size of 7.4 μm×7.4 μm. The field of view is 185 μm×185 μm.

### Holograms Acquisition and Background Correction

As observed in FIG. 3a the recorded fields of view by the DHM show aggregates disseminated on a background field. The main objective is to measure the aggregate shapes thanks to the quantitative phase contrast imaging capability of the DHM. In this section, we describe the processing steps to obtain the complex amplitude information and the resulting phase information on the aggregates.

In digital holographic microscopy, optic elements can introduce minor distortions in the background phase. This is particularly pertinent when the main parameter analyzed is the phase information that allows to quantify the morphological shapes of the platelet aggregates. For that purpose, it is necessary to implement a phase background subtraction and permanent defects elimination. However, to do that, it is necessary to insert the sample in which there are already the aggregates, making it difficult to perform the background phase subtraction on the basis of a single hologram. In order to overcome this issue, we first recorded a sequence of N holograms (in the reported experiment, N=29) of the sample moved with lateral translations. This sequence of holograms allows us to implement corrections of the defects in the intensities and the phase maps in a self-consistent way. The defects correction uses the procedures that are described as follow.

The S complex amplitude gₖ(s,t), where (s,t) are the discrete spatial variables, with k=0, . . . , N−1, s,t=0, . . . , n−1 and n is the pixel number by side, are extracted from a set of recorded hologram hₖ(s,t). The original holograms have a size of 1024×1024 pixels giving rise to complex amplitudes of the same size.

A first step of correction on the intensity field is performed. For that purpose, the averaged intensity iₐ(s,t) of the intensities iₖ(s,t)=|gₖ(s,t)|² is computed. The corrected intensities are computed thanks to:

i_{ck}(st)=iₖ(s,t)/iₐ(s,t) (1)

For the correction of the phase maps φₖ(s,t) associated to gₖ(s,t), the averaged phase map φₐ(s,t) is computed and subtracted to every phase map φₖ(s,t) to obtain the corrected phase maps φ_{ck}(s,t) according to:

φ_{ck}(s,t)=mod_{2π}{φₖ(s,t)−φₐ(s,t)} (2)

The phase background is after set, in average, to a fixed phase value. In our case, for the phase values ranging on 255 levels (1 byte), we set the background to the level 30 to avoid phase jumps. The process is efficient and is illustrated by the FIG. 3 a.

On each recorded hologram, the physical heights hₖ(s,t) are determined by:

$${h}_{k} ( s , t ) = \frac{{ϕ}_{k} ( s , t ) λ}{255 ( {n}_{2} - {n}_{1} )} \qquad ( 3 )$$

Where n₂ is the platelet refractive index (n₂=1.399) and n₁ is the air refractive index (n₁=1).

### Results and Discussion

### Platelet Aggregate Detection

In the aim to determine the phase error, the regions covered by the aggregates were detected to evaluate the phase fluctuations outside those regions. Those ones are then used to establish the accuracy of the phase measurements. The detection processing that we used is identical to the one described by C. Yourassowsky and F. Dubois in “High throughput holographic imaging-in-flow for the analysis of a wide plankton size range” Opt. Express 22, 6661-6673 (2014). It is based on a high-pass filtering of the g_{ck}(s,t). Indeed, when there is locally no aggregate in some areas of the field of view, g_{ck}(s,t) is almost constant in this region and the high-pass filtering process gives complex amplitude with very low module values that are eliminated by a simple threshold operation. On the contrary, the high-pass filtering enhances the presence of an aggregate by local strong complex amplitude.

To avoid border effects by the high-pass filter, it is constituted by an inverse Gaussian filter H(u,v) defined by:

H(u,v)=(1−exp{−(u²+V²)/2σ²}) (4)

Where (u, v) are the discrete spatial frequencies (u,v=−n/2, . . . ,n/2−1), and σ is the width of the high-pass filter. In practice, σ=10 gives good results. After the inverse Fourier transformation in the filtering process, a threshold is applied. The intensity image is computed and converted into 255 gray levels in such a way that aggregates give rise to bright regions, even with saturation, and that the background regions give intensity of few grey levels (typically less than 10). The threshold level we applied is 40. It results binary images constituted by a dark background in which there are unconnected bright regions. A surface analysis is performed in order to eliminate the smaller areas (<4pixels). A morphological dilatation is performed with a 10-pixels diameter structural element in order to guarantee that the bright areas partly cover already the background region.

As we want to assess the fluctuation of the phase background, we invert the contrast to obtain a mask on which the background fluctuations are computed. An example of result is shown in FIG. 3.b.

The full set of phase images is used to assess the fluctuations of the phase background by computing the standard deviation that is given by StDev=3.2 grey level. Considering this value as the typical error on the phase, we obtain, tanks to Eq. (3), that the error Δh on the height of the aggregates is 17.05 nm. By using classical statistical tools, it results that the error on the volume of an aggregate ΔV can be expressed by:

ΔV=s\sqrt{NΔh} (5)

Where s is the pixel area and N the number of pixel covered by the aggregate. Thanks to Eq. (5), assessment of the error on the volume computation is given here below.

### Computation of the Volume of the Platelet Aggregates

The volume of the aggregate a in the hologram k is obtained by computing in the corresponding phase image:

$${V}_{ka} = s {\sum }_{l , m = 0}^{n} {h}_{k} ( l , m ) {w}_{ka} ( l , m ) \qquad ( 6 )$$

Where s is the area of one pixel, n is the number of pixels by phase image side and wₖₐ (l,m) is a region of interest function that is equal to 1 when the pixel belongs to the aggregate a, and which is zero elsewhere. wₖₐ(l,m) can be achieved by performing:
1/ a morphological dilatation on each non-zero valued zone of the binary detection image obtained by the method described above;
2/ As each resulting zone will exceed the actual area of the corresponding aggregate, a low-level threshold operation is performed (Threshold value=background level+3 grey levels) in order to keep the only pixels belonging to the aggregate.

However, with this method it is not excluded to have overlaps between some neighbor aggregates that could influence the assessment of the aggregate volume. For that reason, we decided to select regions of interest that are not too close to each other to avoid the overlaps effect. This was performed to have a statistical relevance. On the basis of 29 original holograms corresponding to shear rate exposition times of 20 s and 300 s, we processed a total of 340 platelet aggregates. To observe the platelet aggregates spreading process, we exposed whole blood to a constant shear rate (100 s⁻¹) during 20 sec and 300 sec. As first indications, for those expositions, the averaged platelet volumes are, respectively, 4.50 μm³ and 3.74 μm³ with the average errors of 0.015 μm³ in both cases. More significant information were extracted as described below. This average error of less than 0.5% is surprisingly low.

On the FIG. 4, we show the different steps of the analysis. The well of the impact-R test is placed on the motorized table of the DHM for analysis (FIG. 4 a). The FIG. 4 d shows a zoom on an aggregate and a 3D representation extracted from the phase, where the spreading is clearly observable.

DHM allows to extract aggregates maximal highs, surfaces and volumes. On the FIG. 5, we observe the highs, surfaces and volumes of aggregates obtained with the whole blood exposed to a shear rate of 100 s⁻¹, after 20 sec and 300 sec. A significant decrease is observed after 300 sec for the highs (p<0.001) and the volumes (p=0.003). In contrast, the surfaces increase after 300 sec (p<0.001). On the FIGS. 5(d) and 5(e), we plot the correlations between the volumes (Vol) and the product of the maximum high by the aggregate surface (S×H). A tight association between the global volume and the S×H product is observed. At 20 sec, the angular coefficient of the regression is 0.24 and at 300 sec, when the volumes decrease due to the spreading, the coefficient is 0.20. It is the first time that this observation is reported.

Platelet receptors and cytoplasmic molecules, such as calpain-1 and talin involved in cascades after adhesion and activation have been extensively studied. However, the effect of these cascades on plug morphology have been commonly analyzed through the transmission microscopy alone or combined with fluorescence but in 2D. The DHM is very convenient to use and it could give more data on the role of molecules involved in the spreading. By using a flow chamber directly on the DHM, it is possible to study dynamically the formation of platelets aggregates but in 3D.

### Example 2 Chronic Obstructive Pulmonary Disease (COPD) Detection

COPD (chronic obstructive pulmonary disease) is a major cause of death worldwide with estimates projecting it as the third cause of death in 2020. One of the important characteristics of this disease is the presence of both the lung and systemic chronic low-grade inflammation. In addition, observational studies show a strong statistical association between COPD and cardiovascular disease.

Systemic inflammation has been identified as a causal factor for atherosclerosis although all the mechanisms involved are not all known. The systemic low-grade inflammation, hypoxia and oxidative stress are factors that may explain the increased cardiovascular risk and mortality in COPD. During exacerbations the systemic inflammation increases, hypoxia is more marked and it has been shown with autopsies of COPD patients died during an exacerbation, that the main causes of death were due either to a decompensated heart failure (37%) or pulmonary embolism (21%). Donaldson et al suggested in 2013 that the risk of cardiovascular events was increased in these patients during an exacerbation. They report a relative risk of myocardial infarction of 2.3 (1.1 to 4.7) to five days after the onset of exacerbation. In recent years, the potential role of platelet activation in the genesis of atherothrombotic events has been demonstrated in smokers and patients suffering from COPD. During this year a study in Pneumology has been performed to study in patients (11 COPD exacerbation, 16 stable COPD and 13 controls) platelet aggregates in 3D.

The present example shows the interest of the quantitative data that can be obtained by the method of the invention in helping diagnosis of COPD complications.

### Material and Methods

The diagnosis of COPD is based on the GOLD classification (Table 1) obtained from pulmonary function tests (PFT). The pulmonary function tests are those already previously performed in stable condition or performed at discharge.

The patients aged over 45 years, with moderate to severe COPD (Stage II-III-IV) with or without hypoxemia, in stable condition or exacerbation were included in the study.

Exacerbations were defined based on the following symptoms: increase of the dyspnea, cough and/or sputum. Exacerbations were classified when infectious pathogen was found in sputum or when the patient had received antibiotics. (Based on Anthonisen criteria, an inflammatory syndrome or a radiological image compatible with pneumonia)

COPD patients were matched for age and sex with non-smoking healthy sublects.

TABLE 1
FEV1/FVC ratio < 0.7

| | | |
|---|---|---|
| Stage I | Mild | FEV1 > 80% |
| Stage II | Moderate | 50% < FEV1 < 80% |
| Stage III | Severe | 30% < FEV1 < 50% |
| Stage IV | Very severe | FEV1 < 30% |

FEV1: Forced Expiratory Volume in 1 second.
FVC: Forced vital capacity: the determination of the vital capacity from a maximally forced expiratory effort.

### Exclusion Criteria

Patients with other respiratory diseases (such as pulmonary fibrosis) or unstabilized heart disease, or a cancer or cirrhosis, were excluded. Patients taking antiplatelet agents such as clopidogrel or anti vitamin K (acenocoumarol), were also excluded.

Among 23 patients hospitalized with exacerbation of COPD, 11 patients (10 superinfected and 1 not superinfected) could be included in the study. 12 patients were excluded (4 for associated cardiac failure, pulmonary fibrosis associated to 1, 2 for failure samples, 2 for refusal, 1 Hepatitis C and 2 for taking Sintrom)

Among 22 COPD patients selected by consultation, 16 in stable condition patients were included in the study. 6 patients could not be included (2 for refusal, 2 for severe heart failure associated exacerbation and 2 for COPD exacerbation at the time of consultation).

For each patient, a careful history was made and the computer records were consulted in search of the history of home treatment, to stop a smoking, long-term oxygen therapy at home, presence an associated emphysema.

Thirteen control subjects of exacerbation in patients were taken.

Patients in exacerbation and in stable condition were subjected to arterial blood samples (to assess the degree of hypoxemia) and venous blood samples for the study of hematological parameters (number of leukocytes, platelets and red blood cells, CRP, fibrinogen). The control patients have been venous samples. Blood samples were taken within 48 hours of admission for patients in exacerbation.

### Results

The FIG. 6 shows that the shape of the aggregates—Quantified by the ratio aggregate height/aggregate surface, both measured on the optical phase information—between the three groups is not altered at low shear rate (100 s−1). In contrast, at high shear rate (5000 s−1), FIG. 7 the ratio height/surface in exacerbated COPD patients is significantly increased. This indicates that the shear rate and the presence of an exacerbation play a role on the aggregate formation.

It is the first time that an alteration of the of the platelet aggregates morphology is observed in COPD patients. It is well known that platelets play a key role in the occurrence of cardiovascular events. Based on clinical studies it would be possible to show that the alteration of the morphology of platelet aggregates could be used in the prediction of a thromboembolic event. This can be applied to other pathologies such as diabetes, hypertension, autoimmune disease, sepsis, renal failure, etc. Thus, all diseases well known to increase cardiovascular events.

### CONCLUSION

The DHM allows to study the morphological dynamic of the platelets adhesion, aggregation and spreading in in-vitro models. This original method is of a great interest in the study of platelets physiology, physiopathology in clinical practice and in the development of new drugs. It is the first time that platelets aggregates are analyzed by DHM.

1-7. (canceled)

8. Method for the quantitative analysis of blood platelets and aggregates comprising the steps of:
a) providing a sample comprising blood platelets aggregates;
b) obtain a 3D representation of the platelets aggregates by the use of DHM or DDHM;
c) extract quantitative information about the platelets aggregates from said 3D representation,
wherein said quantitative information is related to the group consisting of shape (such as form factor), volume, spreading, surface, surface to volume ratio, and squared aggregate perimeter to aggregate area ratio.

9. Method according to claim 8 wherein said platelets aggregates are adhering on a surface.

10. Method according to claim 9 wherein the step of providing blood platelets aggregates comprises the steps of providing platelets in suspension and submit said platelets in suspension to a predefined shear rate in the vicinity of the surface prior to observation by DHM or DDHM.

11. Method according to claim 10 wherein the quantitative analysis is performed dynamically, step b) and c) being performed iteratively on a sample submitted to a controlled shear rate.

12. Method according to claim 8 comprising the step of acquiring both holographic and fluorescence images of the cells.

13. Method according to claim 8 comprising the step of subtracting an estimation of the background prior to quantitative analysis.
